(19) United States
(12) Patent Application Publication
(10) Pub. No.: US 2010/0148509 A1
(43) Pub. Date: Jun. 17, 2010

(54) Ortiz turbine

(76) Inventor: Israel Ortiz, Guayama, PR (US)

Correspondence Address: Israel Ortiz, P.O. Box 1326, Guayama, PR, 00785, US

(21) Appl. No.: 12/316,420

(22) Filed: Dec. 12, 2008

(51) Int. Cl. F03B 13/12

(52) U.S. Cl. 290/53

(57) ABSTRACT

The Ortiz turbine is designed to collect the kinetic energy of water currents, be this at sea, river or at the beach. It is composed of a omni-directional turbine a generator and a main axle that holds together the whole structure. This main axle also attaches the turbine to the bottom of the sea,river or beach. Since it is composed of an omni-directional turbine it will extract the energy of currents that oscillate back and forward like on the beach, also can have vanes long enough to capture different currents with different directions on top or bottom of the sea or river.

### FIELD OF THE INVENTION

The present invention relates to an omni-directional turbine and, more particularly, to a vertical axis turbine designed to produce power from water currents or water that oscillates back and forward like in a beach.

### BACKGROUND OF THE INVENTION

It is well known that today the demand for energy is increasing at an accelerated speed. It is also well known that to produce energy we use fuels that are very toxic and dangerous. There are ways to produce such energy in a more safe manner. One of them being the sea or rivers. This form of energy is none toxic and completely renewable. Also since water is more dense than air, the flow of water can produce more energy than air.

Using nuclear power is not a good solution. because no mater how many safety solutions they have, they will never be save. Examples of this is Three Mile Island and Chernoville.

As all ready said, Chernoville is an example of the very high possibilities of something going wrong with nuclear power. Today Chernoville is a ghost town and it will take many years before people can return there.

It is therefore an object of the invention to produce power from running water.

It is another object of the invention to have few moving parts.

It is another object of the invention to use only one support to the bottom of the sea or river.

It is another object of the invention to be able to be constructed at small or large scales depending on the amount of power needed.

It is another object of the invention to be able to have the turbine under water and the generator chamber outside the water for easy maintenance.

It is another object of the invention to be able to in water currents that are constantly changing directions.

### SUMMARY OF THE INVENTION

In accordance with the present invention, there is provided on omni-directional turbine and a generator, that are connected by a main axle. There is also provided a chamber that houses the generator and pulleys or transmission. The generators chamber is oval in shape, so as to provide little resistance to the water current or flow. Also the chamber will keep the generator dry because it is water sealed. The omni-directional turbine has vertical vanes that are placed 360 degrees around the turbine. Here the energy is transferred to the generator from the turbine by means of pulleys and belt, although gears or a transmission could be used. The turbine will spin in one direction no matter from what direction the flow is coming from. So the omni-directional turbine will turn as the water current pushes it, no matter if the direction of the current is constantly changing. This energy will be transferred to the generator by the belt and pulleys as already explained. The whole mechanical function is held together by one main axle, making it very easy to construct and operate. The generator chamber can be placed under water or above the water line. Above the water line the maintenance to the generator and other control systems will be easier and much more practical. The Ortiz turbine could be used in a river at the sea or on the beach. Any where there is a current or oscillation of water. For example in a river where the water is flowing in one direction. On the beach where the water is oscillating back and forward. Or in the sea where you have different surface or deep sea currents. The Ortiz turbine can be made to have long vanes that stretch from surface to bottom of the sea. And even if the surface currents do not run in the some direction as the deep currents the turbine will extract the power from both of them, because the turbine is omni-directional. Making it very efficient and powerful.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front perspective view of an ortiz turbine here is seen with the 3 main parts, the chamber which is oval in shape and is under the chamber cover 2, the omni-directional turbine 20 composed of vertical vanes 19 and the main axle 1;

FIG. 2 is a front partial view of a chamber cover 20 and chamber floor 13 removed, here we see some of the parts that are housed in the chamber;

FIG. 3 is a top detail view of a chamber cover 2 and chamber floor 13 removed, again showing the parts that are housed under the chamber, like the generator 3, belt 5, omni-directional turbine pulley and other parts;

FIG. 4 is a front detail view of an ortiz turbine showing an x ray view of the different parts of inner workings of the turbine. like the omni-directional turbine 20 and other parts;

FIG. 5 is a front exploded view of an ortiz turbine showing the relation between the different parts;

FIG. 6 is a top detail view of a chamber cover 2 and chamber floor removed, to show the vertical vanes 19;

FIG. 7 is a right view of an ortiz turbine being used at the beach where there is an oscillating wave back and forward;

FIG. 8 is a view of the turbine being used at sea or a river with long vertical vanes; and

FIG. 9 is a view of the turbine being used at the bottom of a river or sea.

For purposes of clarity and brevity, like elements and components will bear the same designations and numbering throughout the Figures.

### DESCRIPTION OF THE PREFERRED EMBODIMENT

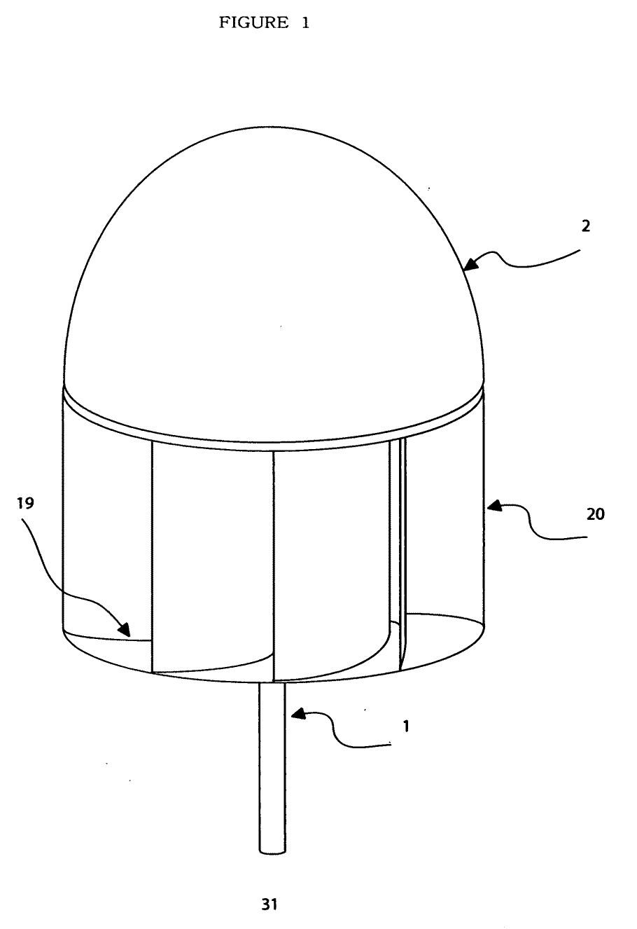

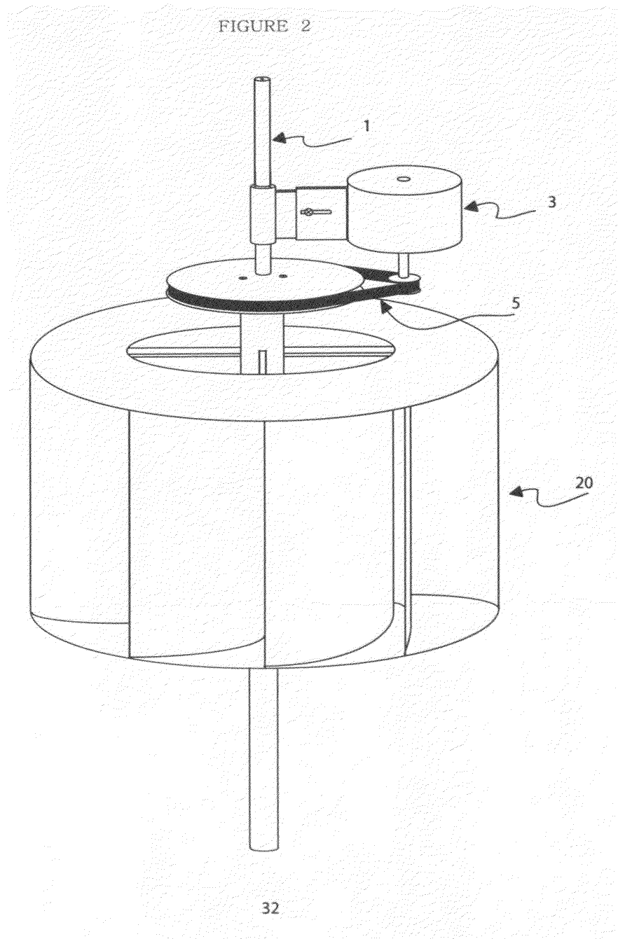

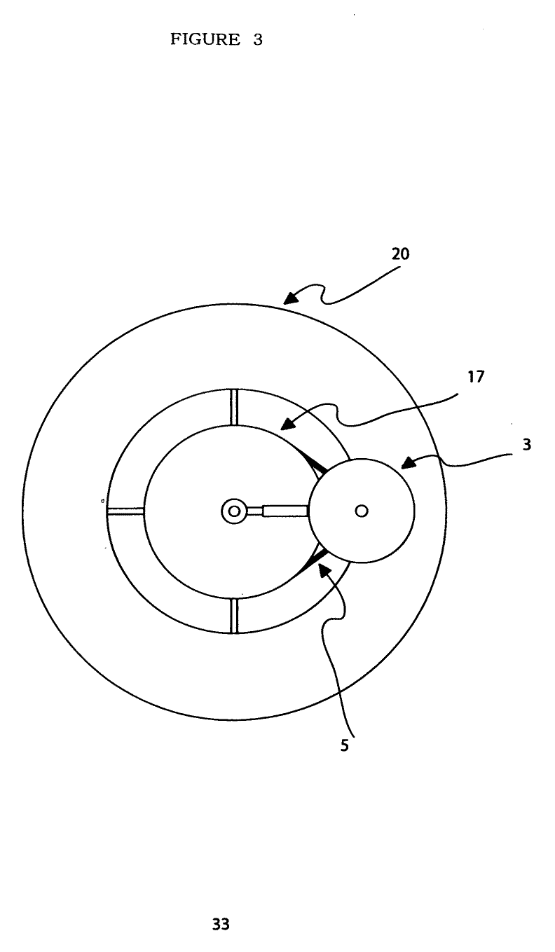

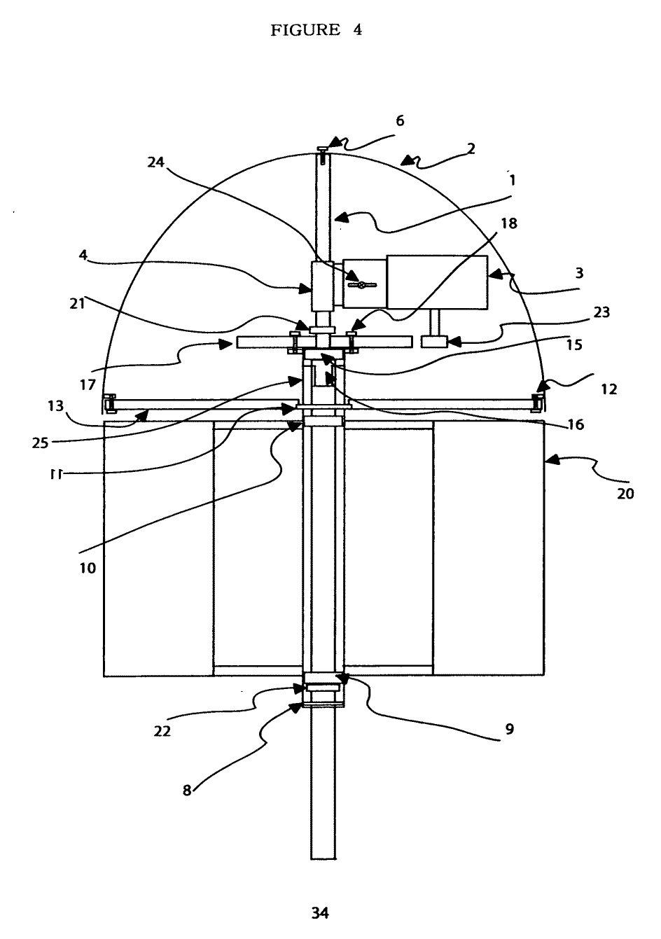

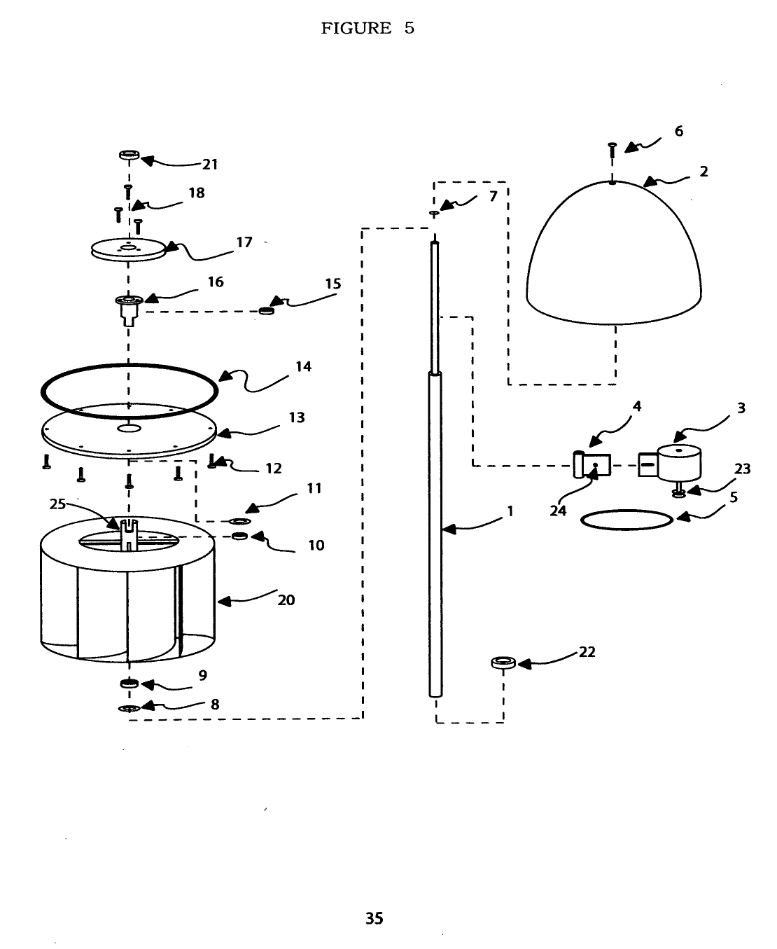

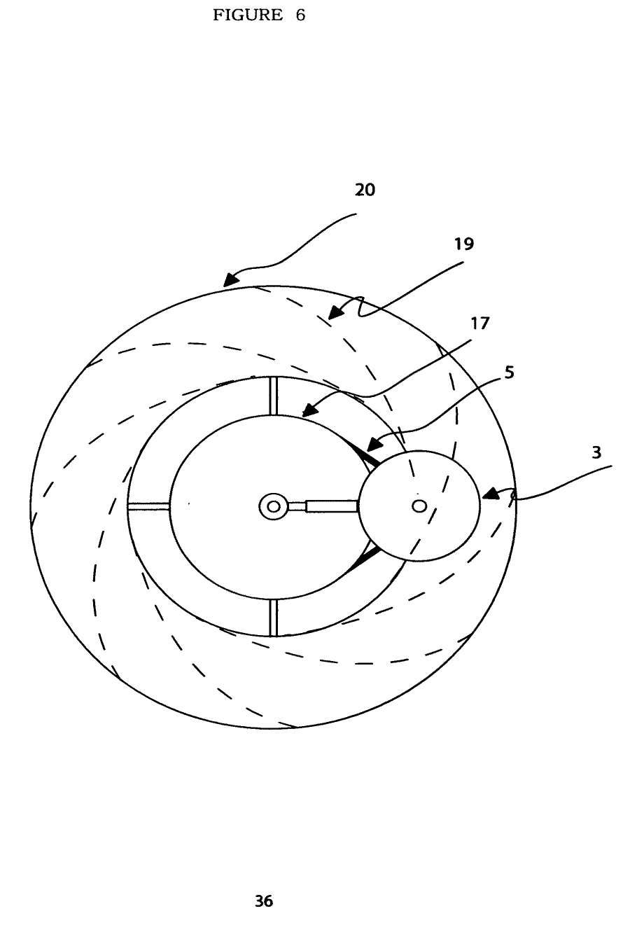

The Ortiz turbine is an omni-directional turbine designed to capture the kinetic energy of any running or current of water. Be this at sea, river or any large body of water. Doing this even if the water is constantly changing directions like on the beach. As shown in FIG. 1 it is composed of a omni-directional turbine 20 with vertical axis, vertical vanes 19 and a chamber to house the generator 3 and control systems. Also a main axle 1 that holds the structure together and fixes the turbine to the bottom of the river, sea, beach or any large body of water. In FIG. 2 we see the main parts that are housed under the chamber cover 2. In FIG. 3 we see a top detail view of the the turbine, here we can see the generator 3, the belt 5 that connects the omni-directional turbine pulley 17 to the generator pulley 23 and the omni-directional turbine 20. FIG. 4 is a front detail view of the turbine. Here is the generator holder 4 that fixes the generator 3 to the main axle 1 and an adjusting screw 24 to stretch the belt 5 to the correct tension. We also see the main axle 1 that holds the omni-directional turbine 20, generator 3, omni-directional turbine pulley 17, upper secondary axle 16, upper ball bearing 15, middle ball bearing 10, lower ball bearing 9, upper collar 21 and lower collar 22. The upper collar 21 and lower collar 22, hold all the parts to the main axle 1. The omni-directional turbine 20 will rotate on the upper ball bearing 15, middle ball bearing 10 and the lower ball bearing 9. In FIG. 4 the pulley screws 18 hold the omni-directional turbine pulley 17 to the omni-directional turbine 20 via the upper secondary axle 16. The upper secondary axle 16 fits into the central hub 25 of the omni-directional turbine 20 by means of a notch, the upper secondary axle 16 has a male notch and the central hub 25 has a female notch. FIG. 5 is an exploded view of the whole structure. In FIG. 4 and FIG. 5 we see that the chamber floor 13 is held to the chamber cover 2 by means of the floor holding screws 12, also a floor seal 14 fits between the chamber floor 13 and the chamber cover 2 to make the chamber water proof. Between the central hub 25 and the chamber floor 13 there is a upper seal 11 to keep the water from entering the chamber. In FIG. 4 and FIG. 5 we see a lower seal 8 and a upper seal 11 that seals the water out of the central hub 25, also a upper chamber seal 7 that seals the water from the chamber. There is a chamber screw 6 that holds the chamber cover 2 to the main axle 1. In FIG. 6 there is shown the vertical vanes 19 that the omni-directional turbine has and how they are distributed alone the 360 degrees of the omni-directional turbine 20. Here the omni-directional turbine 20 is shown mechanically connected to the generator 3 using a belt 5 and pulleys, but this can be replaced by two gears or a transmission. Also a flywheel can be connected at the bottom of the omni-directional turbine 20 to make the rotation more constant, especially when used on the beach where there is more turbulence.

The operation of the Ortiz turbine is as fallows, the omni-directional turbine 20 will rotate when it comes in contact with running water. This is because the vanes on the right side are open to the incoming water and this vanes will be pushed by the water, on the left side the vanes are overlapping and will offer little resistance to the water, there for, there will be an imbalance of the forces that hit the omni-directional turbine 20 head on and will cause a rotation on the omni-directional turbine 20. This kinetic energy will be transferred to the generator 3 by the belt 5 and pulleys. In the generator 3 the kinetic energy will be converted to electrical energy.

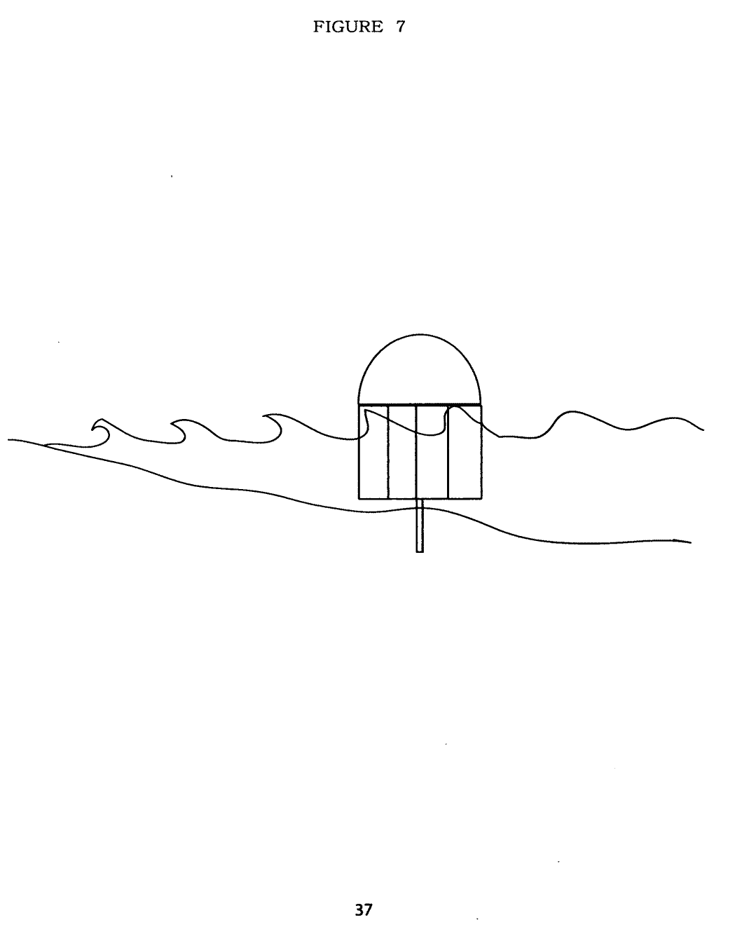

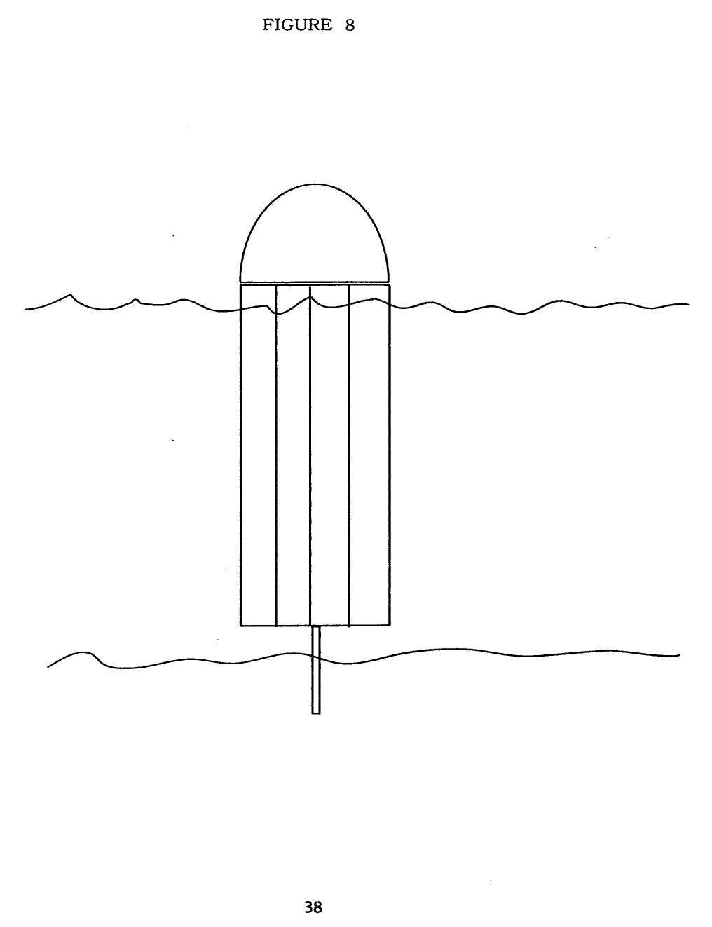

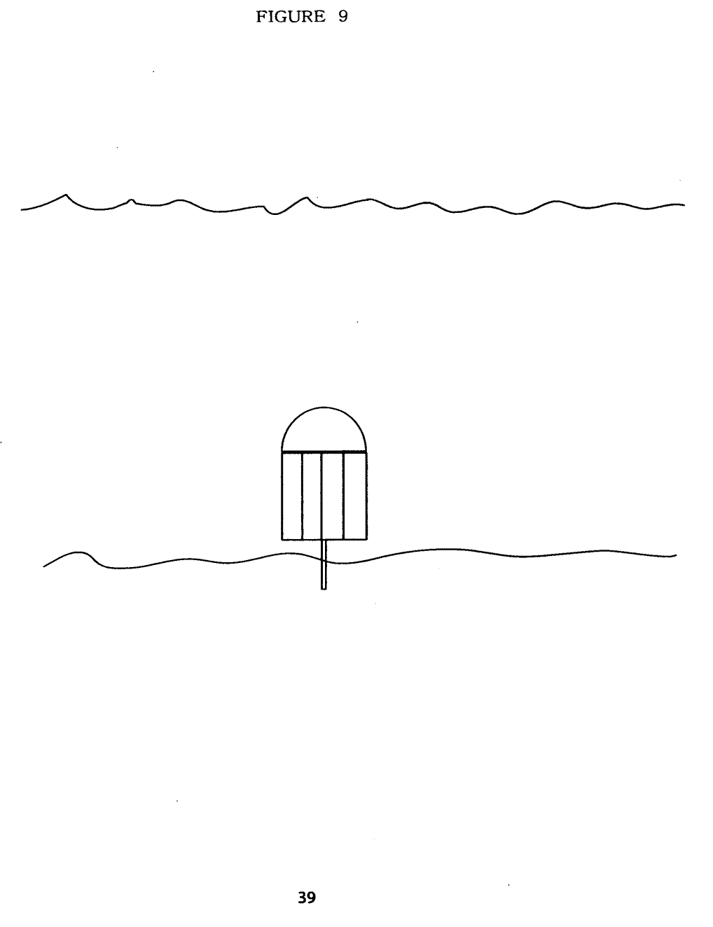

In FIG. 7, FIG. 8 And FIG. 9 is shown some of the ways this turbine can be used. In Fugue 7 it is been used at the beach where the oscillations of the waves, back and forward provide the energy to the turbine, here the turbine is attached to the bottom by the main axle 1.

FIG. 8 we see the turbine been used at sea, here it has longer vanes that reach from top to bottom of the sea or river. The purpose is to collect energy from top of the water and also from the deep, this even if the top currents and the deeper currents do not run exactly in the same direction. Also the chamber is above the water so the maintenance is easy to accomplish.

In FIG. 9 the turbine is under water be at sea or river where the currents are greater.

The Ortiz turbine can be designed with different dimensions, for example a 4 or 5 feet long for use on the beach, or 100 feet or more with vanes that run vertically from top to bottom of the sea or river. So that it can extract power from top and bottom currents even if they do not run in the same direction because it has an omni-directional turbine.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An ortiz turbine for generating power from water currents that are present at sea, rivers or any large body of water, comprising:
means for holding together the whole structure of the ortiz turbine and to fix the ortiz turbine to the bottom of the sea or river;
means for forming the generator chamber in connection with the chamber floor;
means for converting the mechanical energy to electrical energy;
means for holding the generator to the main axle;
means for transferring the power from the omni-directional turbine to the generator via the polleys;
means for holding the chamber cover to the main axle;
means for sealing the chamber from the outside water;
means for sealing the water out of the central hub and the main axle;
means for fixing the omni-directional turbine to the main axle and to function as a bearing where it can rotate;
means for fixing the omni-directional turbine to the main axle and to function as a bearing where to rotate;
means for sealing the water out of the chamber;
means for fixing the chamber floor to the chamber cover;
means for forming the chamber with the chamber cover;
means for sealing the water outside the chamber. it fits between chamber floor and the chamber cover;
means for fixing the upper secondary axle to the main axle and as a bearing where the omni-directional turbine will rotate;
means for attaching the omni-directional turbine pulley to the omni-directional turbine;
means for transferring the mechanical energy from the omni-directional turbine to the generator by means of the belt;
means for interacting with the water in such a way that the water will push the side of vanes that are open to the incoming water and cause rotation of the omni-directional turbine;
means for capturing the kinetic energy of the water current;
means for holding the assembly of the turbine together;
means for holding the assembly of the turbine together;
means for transferring the kinetic energy from the belt to the generator;
means for adjusting the belt to the correct tension;
means for fixing the omni-directional turbine pulley to the omni-directional turbine via the upper secondary axle; and
means for holding the lower and middle ball bearings where the omni-directional turbine will rotate.

2. The ortiz turbine in accordance with claim 1, wherein said means for holding together the whole structure of the ortiz turbine and to fix the ortiz turbine to the bottom of the sea or river comprises a main axle.

3. The ortiz turbine in accordance with claim 1, wherein said means for forming the generator chamber in connection with the chamber floor comprises a chamber cover.

4. The ortiz turbine in accordance with claim 1, wherein said means for converting the mechanical energy to electrical energy comprises a generator.

5. The ortiz turbine in accordance with claim 1, wherein said means for holding the generator to the main axle comprises a generator holder.

6. The ortiz turbine in accordance with claim 1, wherein said means for transferring the power from the omni-directional turbine to the generator via the polleys comprises a belt.

7. The ortiz turbine in accordance with claim 1, wherein said means for holding the chamber cover to the main axle comprises a chamber screw.

8. The ortiz turbine in accordance with claim 1, wherein said means for sealing the chamber from the outside water comprises an upper chamber seal.

9. The ortiz turbine in accordance with claim 1, wherein said means for sealing the water out of the central hub and the main axle comprises a lower seal.

10. The ortiz turbine in accordance with claim 1, wherein said means for fixing the omni-directional turbine to the main axle and to function as a bearing where it can rotate comprises a lower ball bearing.

11. The ortiz turbine in accordance with claim 1, wherein said means for fixing the omni-directional turbine to the main axle and to function as a bearing where to rotate comprises a middle ball bearing.

12. The ortiz turbine in accordance with claim 1, wherein said means for sealing the water out of the chamber comprises an upper seal.

13. The ortiz turbine in accordance with claim 1, wherein said means for fixing the chamber floor to the chamber cover comprises a floor holding screws.

14. The ortiz turbine in accordance with claim 1, wherein said means for forming the chamber with the chamber cover comprises a chamber floor.

15. The ortiz turbine in accordance with claim 1, wherein said means for sealing the water outside the chamber. it fits between chamber floor and the chamber cover comprises a floor seal.

16. The ortiz turbine in accordance with claim 1, wherein said means for fixing the upper secondary axle to the main axle and as a bearing where the omni-directional turbine will rotate comprises an upper ball bearing.

17. The ortiz turbine in accordance with claim 1, wherein said means for attaching the omni-directional turbine pulley to the omni-directional turbine comprises an upper secondary axle.

18. The ortiz turbine in accordance with claim 1, wherein said means for transferring the mechanical energy from the omni-directional turbine to the generator by means of the belt comprises an omni-directional turbine pulley.

19. The ortiz turbine in accordance with claim 1, wherein said means for interacting with the water in such a way that the water will push the side of vanes that are open to the incoming water and cause rotation of the omni-directional turbine comprises a vertical vanes.

20. The ortiz turbine in accordance with claim 1, wherein said means for capturing the kinetic energy of the water current comprises an omni-directional turbine.

21. The ortiz turbine in accordance with claim 1, wherein said means for holding the assembly of the turbine together comprises an upper collar.

22. The ortiz turbine in accordance with claim 1, wherein said means for holding the assembly of the turbine together comprises a lower collar.

23. The ortiz turbine in accordance with claim 1, wherein said means for transferring the kinetic energy from the belt to the generator comprises a generator pulley.

24. The ortiz turbine in accordance with claim 1, wherein said means for adjusting the belt to the correct tension comprises an adjusting screw.

25. The ortiz turbine in accordance with claim 1, wherein said means for fixing the omni-directional turbine pulley to the omni-directional turbine via the upper secondary axle comprises a pulley screws.

26. The ortiz turbine in accordance with claim 1, wherein said means for holding the lower and middle ball bearings where the omni-directional turbine will rotate comprises a central hub.

27. An ortiz turbine for generating power from water currents that are present at sea, rivers or any large body of water, comprising:
a main axle, for holding together the whole structure of the ortiz turbine and to fix the ortiz turbine to the bottom of the sea or river;
a chamber cover, for forming the generator chamber in connection with the chamber floor;
a generator, for converting the mechanical energy to electrical energy;
a generator holder, for holding the generator to the main axle;
a belt, for transferring the power from the omni-directional turbine to the generator via the polleys;
a chamber screw, for holding the chamber cover to the main axle;
an upper chamber seal, for sealing the chamber from the outside water;
a lower seal, for sealing the water out of the central hub and the main axle;
a lower ball bearing, for fixing the omni-directional turbine to the main axle and to function as a bearing where it can rotate;
a middle ball bearing, for fixing the omni-directional turbine to the main axle and to function as a bearing where to rotate;
an upper seal, for sealing the water out of the chamber;
a floor holding screws, for fixing the chamber floor to the chamber cover;
a chamber floor, for forming the chamber with the chamber cover;
a floor seal, for sealing the water outside the chamber. it fits between chamber floor and the chamber cover;
an upper ball bearing, for fixing the upper secondary axle to the main axle and as a bearing where the omni-directional turbine will rotate;
an upper secondary axle, for attaching the omni-directional turbine pulley to the omni-directional turbine;
an omni-directional turbine pulley, for transferring the mechanical energy from the omni-directional turbine to the generator by means of the belt;
a vertical vanes, for interacting with the water in such a way that the water will push the side of vanes that are open to the incoming water and cause rotation of the omni-directional turbine;
an omni-directional turbine, for capturing the kinetic energy of the water current;
an upper collar, for holding the assembly of the turbine together;
a lower collar, for holding the assembly of the turbine together;
a generator pulley, for transferring the kinetic energy from the belt to the generator;
an adjusting screw, for adjusting the belt to the correct tension;
a pulley screws, for fixing the omni-directional turbine pulley to the omni-directional turbine via the upper secondary axle; and
a central hub, for holding the lower and middle ball bearings where the omni-directional turbine will rotate.

28. An ortiz turbine for generating power from water currents that are present at sea, rivers or any large body of water, comprising:
a main axle, for holding together the whole structure of the ortiz turbine and to fix the ortiz turbine to the bottom of the sea or river;
a chamber cover, for forming the generator chamber in connection with the chamber floor;
a generator, for converting the mechanical energy to electrical energy;
a generator holder, for holding the generator to the main axle;
a belt, for transferring the power from the omni-directional turbine to the generator via the polleys;
a chamber screw, for holding the chamber cover to the main axle;
an upper chamber seal, for sealing the chamber from the outside water;
a lower seal, for sealing the water out of the central hub and the main axle;
a lower ball bearing, for fixing the omni-directional turbine to the main axle and to function as a bearing where it can rotate;
a middle ball bearing, for fixing the omni-directional turbine to the main axle and to function as a bearing where to rotate;
an upper seal, for sealing the water out of the chamber;
a floor holding screws, for fixing the chamber floor to the chamber cover;
a chamber floor, for forming the chamber with the chamber cover;
a floor seal, for sealing the water outside the chamber. it fits between chamber floor and the chamber cover;
an upper ball bearing, for fixing the upper secondary axle to the main axle and as a bearing where the omni-directional turbine will rotate;
an upper secondary axle, for attaching the omni-directional turbine pulley to the omni-directional turbine;
an omni-directional turbine pulley, for transferring the mechanical energy from the omni-directional turbine to the generator by means of the belt;
a vertical vanes, for interacting with the water in such a way that the water will push the side of vanes that are open to the incoming water and cause rotation of the omni-directional turbine;
an omni-directional turbine, for capturing the kinetic energy of the water current;
an upper collar, for holding the assembly of the turbine together;
a lower collar, for holding the assembly of the turbine together;
a generator pulley, for transferring the kinetic energy from the belt to the generator;
an adjusting screw, for adjusting the belt to the correct tension;
a pulley screws, for fixing the omni-directional turbine pulley to the omni-directional turbine via the upper secondary axle; and
a central hub, for holding the lower and middle ball bearings where the omni-directional turbine will rotate.
